(19) United States
(12) Patent Application Publication
(10) Pub. No.: US 2026/0200232 A1
(43) Pub. Date: Jul. 16, 2026

(54) INKJET RECORDING APPARATUS AND INKJET RECORDING METHOD

(71) Applicant: KYOCERA DOCUMENT SOLUTIONS INC., OSAKA (JP)

(72) Inventor: AKIFUMI NABE, OSAKA (JP)

(21) Appl. No.: 19/446,959

(22) Filed: Jan. 13, 2026

(30) Foreign Application Priority Data
Jan. 15, 2025 (JP) 2025-005674

(51) Int. Cl. B41J 2/17; B41J 2/18; B41J 2/19; C09D 11/322; C09D 11/38

(52) U.S. Cl. CPC B41J 2/1707; B41J 2/18; B41J 2/19; C09D 11/322; C09D 11/38; B41J 2202/07

(57) ABSTRACT

An inkjet recording apparatus includes a circulation section having a circulation path connecting an ejection head and an ink tank that circulates ink between the ejection head and the ink tank at a flow rate of 40 ml/min or more and 70 ml/min or less via the circulation path, a degassing section provided in the circulation path that degasses the ink flowing through the circulation path, and a control section that controls the ejection head to eject the ink after the circulation section circulates the ink. The ink contains a pigment, a glycol ether, a water-soluble organic solvent, a water-insoluble resin, a silicone-based surfactant, and water. Static surface tension of the ink is 25 mN/m or less. Shear viscosity of the ink is 5.5 mPa·s or more and 7 mPa·s or less. A drying rate of the ink is 28% or more and 35% or less at 60 seconds after the ejection from the ejection head.

### CROSS-REFERENCE TO RELATED PATENT APPLICATION

This application claims the benefit of Japanese Priority Patent Application JP 2025-005674 filed on Jan. 15, 2025, the entire contents of which are incorporated herein by reference.

### FIELD OF THE DISCLOSURE

The present disclosure relates to an inkjet recording apparatus and an inkjet recording method.

### BACKGROUND OF THE DISCLOSURE

There is known a water-based ink for forming an image on a medium using an inkjet recording apparatus. For such water-based ink, high adhesion to an impermeable medium is essential when forming the image on the impermeable medium with low water permeability. In contrast, there is known a technology that a binder is blended to achieve the high adhesion to the impermeable medium.

However, in the inkjet recording apparatus, ensuring ejection stability becomes difficult with the ink including the binder. On this matter, it has been found that the ejection stability can be ensured by circulating the ink at a high flow rate before ejection to suppress drying of the ink before the ejection. Even though, in the inkjet recording apparatus, increasing the flow rate for circulating the ink before the ejection makes misdirected ejection where the ink is ejected in an unintended direction more likely to occur.

In light of the above circumstances, an object of the present disclosure is to provide an inkjet recording apparatus capable of ensuring ejection stability while suppressing an occurrence of misdirected ejection of ink.

### SUMMARY OF THE DISCLOSURE

In order to achieve the above object, an inkjet recording apparatus according to one embodiment of the present disclosure includes an ejection head for ejecting ink, an ink tank for reserving the ink, a circulation section having a circulation path connecting the ejection head and the ink tank that circulates the ink between the ejection head and the ink tank at a flow rate of 40 ml/min or more and 70 ml/min or less via the circulation path, a degassing section provided in the circulation path that degasses the ink flowing through the circulation path; and a control section that controls the ejection head to eject the ink after the circulation section circulates the ink.

The ink contains a pigment, a glycol ether, 28 mass % or more and 35 mass % or less of a water-soluble organic solvent, a water-insoluble resin, 0.05 mass % or more of a silicone-based surfactant, and water.

The water-soluble organic solvent is at least one of 1,2-propanediol, 3-methyl-1,3-butanediol, 1,2-pentanediol, 2-methyl-1,3-propanediol, 1,3-propanediol, dipropylene glycol, 1,5-pentanediol, and 3-methyl-1,5-pentanediol.

Static surface tension of the ink at 25° C. is 25 mN/m or less.

Shear viscosity of the ink at 32° C. at a shear rate of 105 s−1 is 5.5 mPa·s or more and 7 mPa·s or less.

A drying rate of the ink is 28% or more and 35% or less at 60 seconds after the ejection from the ejection head.

### BRIEF DESCRIPTION OF THE DRAWINGS

FIG. 1 is a schematic configuration diagram of an inkjet recording apparatus according to an embodiment of the present disclosure.

FIG. 2 is an example of an image of dot lines used to evaluate misdirected ejection of ink.

### DETAILED DESCRIPTION OF THE EXEMPLARY EMBODIMENTS

In an inkjet recording apparatus, ensuring ejection stability becomes difficult with ink including a binder. With respect to this, it has been found that the ejection stability can be ensured by circulating the ink before ejection at a high flow rate to suppress drying of the ink before the ejection. Nevertheless, in the inkjet recording apparatus, increasing the flow rate for circulating the ink before the ejection makes it easier for misdirected ejection to occur where the ink is ejected in an unintended direction.

In light of the above circumstances, an object of the present disclosure is to provide an inkjet recording apparatus capable of ensuring the ejection stability while suppressing the occurrence of misdirected ejection of the ink.

Embodiments of the present disclosure will now be described.

### [Inkjet Recording Apparatus]

An inkjet recording apparatus 1 according to one embodiment of the present disclosure forms an image on a recording medium using an ink. The recording medium on which the image is formed by the inkjet recording apparatus 1 is typically an impermeable medium with low ink permeability. The ink used in the inkjet recording apparatus 1 contains a binder to enhance its adhesion to the recording medium and is formulated to have relatively high dryness to prevent bleeding on the recording medium. Details of the ink according to this embodiment will be described later.

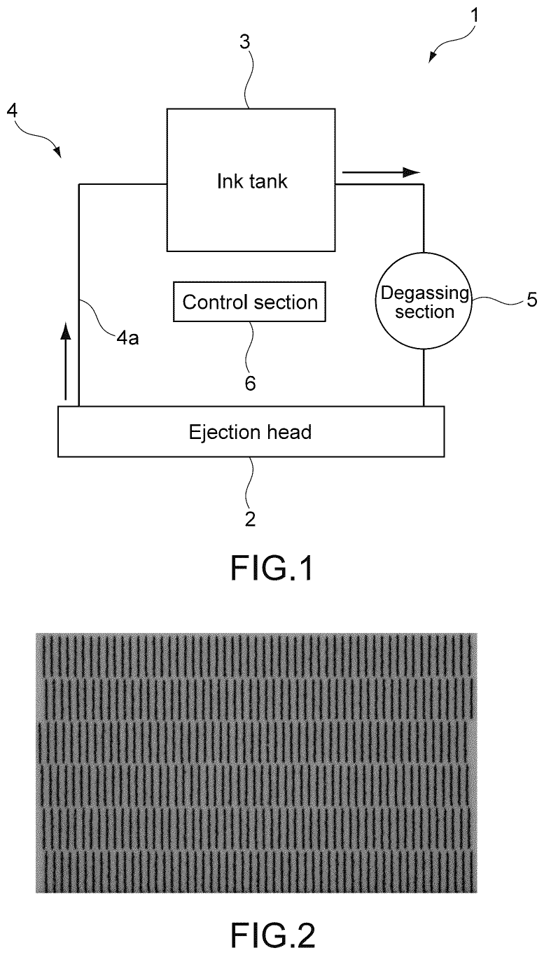

FIG. 1 is a schematic configuration diagram of the inkjet recording apparatus 1. The inkjet recording apparatus 1 includes an ejection head 2, an ink tank 3, a circulation section 4, a degassing section 5, and a control section 6. The ejection head 2 ejects the ink onto the recording medium. The ejection head 2 is typically in a line type and uses a piezoelectric method. The ink tank 3 reserves the ink ejected by the ejection head 2. The circulation section 4 has a circulation path 4a connecting the ejection head 2 and the ink tank 3, and circulates the ink between the ejection head 2 and the ink tank 3 via the circulation path 4a. The degassing section 5 is provided in the circulation path 4a and degasses the ink flowing through the circulation path 4a. The control section 6 controls the ink reserved in the ink tank 3 to be circulated by the circulation section 4 and then ejected by the ejection head 2 onto the recording medium.

In the inkjet recording apparatus 1, the flow rate is relatively large, specifically 40 ml/min or more and 70 ml/min or less when the circulation section 4 circulates the ink before ejection by the ejection head 2. This enables the inkjet recording apparatus 1 to effectively suppress drying even with the ink having the relatively high dryness and to facilitate achieving high ejection stability at the ejection head 2 even with the ink containing the binder.

In the inkjet recording apparatus 1, if the flow rate is large when the circulation section 4 circulates the ink before the ejection by the ejection head 2, it makes it easier for the misdirected ejection, that is a phenomenon where the ink is ejected from the ejection head 2 in an unintended direction, to occur. The inventor of the present invention discovered that such misdirected ejection of the ink occurs due to bubbles present in the ink. Because of this, the inkjet recording apparatus 1 provides the degassing section 5 in the circulation path 4a of the circulation section 4. The degassing section 5 is configured of a known degassing apparatus or degasser that functions to remove the bubbles from the ink flowing through the circulation path 4a.

In the inkjet recording apparatus 1, the circulation section 4 circulates the ink before the ejection by the ejection head 2 via the circulation path 4a. Each time the ink circulating through the circulation path 4a repeatedly passes through the degassing section 5 provided in the circulation path 4a, the bubbles are repeatedly removed by the degassing section 5. Consequently, a dissolved oxygen content decreases over the circulation time. This enables the inkjet recording apparatus 1 to suppress the occurrence of the misdirected ejection of the ink. A time for circulating the ink before the ejection by the ejection head 2 of the circulation section 4 is preferably 0.5 hours or more, and more preferably 1 hour or more. In the inkjet recording apparatus 1, it is preferable that the dissolved oxygen content in the ink immediately before the ejection by the ejection head 2 be 8.5 mg/L or less.

### [Inkjet Recording Method]

An inkjet recording method according to this embodiment can be realized using the inkjet recording apparatus 1 described above. In the inkjet recording method according to this embodiment, a circulation operation to start circulating the ink by the circulation section 4 and a recording start operation to start the ink ejection by the ejection head 2 after a predetermined time has elapsed since the circulation operation may be performed manually without using the control section 6. In this case, the inkjet recording apparatus 1 may not have the control section 6. In the inkjet recording method according to this embodiment, the time for circulating the ink by the circulation section 4 before the ejection by the ejection head 2 is preferably 0.5 hours or more, and more preferably 1 hour or more.

### [Ink]

### (Overall Configuration)

The ink used in the inkjet recording apparatus according to this embodiment is an aqueous ink containing a pigment a, a glycol ether b, a water-soluble organic solvent c, a binder d, a silicone-based surfactant e, and water.

In the ink according to this embodiment, the binder d is blended to improve the adhesion of the image to the recording medium. The ink including the binder d makes it difficult to ensure the ejection stability. In contrast, the inkjet recording apparatus according to this embodiment, as described above, achieves the high ejection stability even with the ink including the binder d by setting the flow rate during the circulation of the ink before the ejection to 40 ml/min or more and 70 ml/min or less.

For the ink of the inkjet recording apparatus, high dryness is desirable to prevent ink bleeding on the recording medium. However, excessively high dryness is undesirable for ensuring the ejection stability at the ejection head. Therefore, in the ink according to this embodiment, the drying rate at 60 seconds after ejection by the ejection head is 28% or more and 35% or less. The drying rate of the ink can be adjusted, for example, by a blending amount of the glycol ether b.

In this embodiment, the ink drying rate is calculated by preparing an ink thin film using a Spin Coater ACT-220AII (manufactured by Active Co., Ltd.) and measuring a weight F0 of the ink thin film immediately after preparation and a weight F1 of the ink thin film at 60 seconds after the preparation using the following equation:

$$Drying rate ( \% ) = ( 1 - F 1 / F 0 ) \times 100$$

Furthermore, the ink according to this embodiment has a static surface tension of 25 mN/m or less at 25° C. This makes the ink according to this embodiment less prone to bubble formation and reduces the occurrence of the misdirected ejection of the ink. The static surface tension of the ink can be adjusted, for example, by the blending amount of the silicone-based surfactant e. In the ink according to this embodiment, a content of the silicone-based surfactant e is 0.05 mass % or more. Furthermore, even when the silicone-based surfactant e is blended into the ink at the content exceeding 0.4 mass %, the static surface tension of the ink hardly changes. Therefore, in the ink according to this embodiment, it is preferable that the content of the silicone-based surfactant e be 0.4 mass % or less.

In this embodiment, the static surface tension of the ink at 25° C. is measured using an automatic surface tension meter DY-300 (manufactured by Kyowa Interface Science Co., Ltd.) by the Wilhelmy method.

Furthermore, in the ink according to this embodiment, a shear viscosity at 32° C. and a shear rate of 105 s−1 is 5.5 mPa·s or more and 7 mPa·s or less. This makes the ink according to this embodiment less prone to the misdirected ejection. The viscosity of the ink can be adjusted, for example, by a blending amount of the water-soluble organic solvent c. In the ink according to this embodiment, a content of the water-soluble organic solvent c is 28 mass % or more and 35 mass % or less.

In this embodiment, the shear viscosity of the ink at a shear rate of 105 s−1 at 32° C. is measured using an image analysis rheometer, Fluidcam Rheo (manufactured by Sanyo Trading Co., Ltd.).

### (Pigment a)

The ink according to this embodiment contains the pigment a as a coloring agent from the perspective of improving color-mixing resistance and water resistance in the image recorded on the recording medium. The pigment a may be either an inorganic pigment or an organic pigment. Furthermore, the pigment a may be used in combination with an extender pigment as needed.

Specific examples of the inorganic pigment usable in the ink according to this embodiment include carbon black and a metal oxide, for example. In particular, carbon black is preferred for a black ink. Examples of carbon black include furnace black, thermal lamp black, acetylene black, and channel black.

Specific examples of the organic pigment usable in the ink according to this embodiment include an azo pigment, a diazo pigment, a phthalocyanine pigment, a quinacridone pigment, an isoindolinone pigment, a dioxazine pigment, a perylene pigment, a perinone pigment, a thioindigo pigment, an anthraquinone pigment, and a quinophthalone pigment.

The ink according to this embodiment is not particularly limited in hue, and any colored pigments such as yellow, magenta, cyan, blue, red, orange, and green can be used. Specific examples of the preferred colored pigment include C.I. Pigment Yellow, C.I. Pigment Red, C.I. Pigment Orange, C.I. Pigment Violet, C.I. Pigment Blue, and C.I. Pigment Green. The ink according to this embodiment may use one or more types selected from the colored pigments as the pigment a.

### (Glycol Ether b)

In the ink according to this embodiment, as the glycol ether b, for example, at least one of diethyl diglycol, diethylene glycol monobutyl ether, ethylene glycol monomethyl ether, ethylene glycol monobutyl ether, diethylene glycol monomethyl ether, diethylene glycol monoethyl ether, diethylene glycol diethyl ether, triethylene glycol monomethyl ether, triethylene glycol monoethyl ether, triethylene glycol monobutyl ether, or propylene glycol monomethyl ether may be used. In the ink according to this embodiment, as the glycol ether b, it is preferable to use triethylene glycol monobutyl ether. In the ink according to this embodiment, it is preferable that a content of the glycol ether b be 13 mass % or more and 17 mass % or less to obtain adequate dryness.

### (Water-Soluble Organic Solvent c)

The water-soluble organic solvent c used in the ink according to this embodiment is at least one of 1,2-propanediol, 3-methyl-1,3-butanediol, 1,2-pentanediol, 2-methyl-1,3-propanediol, 1,3-propanediol, dipropylene glycol, 1,5-pentanediol, and 3-methyl-1,5-pentanediol.

### (Binder d)

The binder d includes fine particles formed from a water-insoluble resin. Examples of the resin forming the binder d include, for example, a (meth)acrylic resin, a styrene resin, a polyvinyl resin, a polyester resin, an amino resin, an epoxy resin, a urethane resin, a polyether resin, a polyamide resin, a phenol resin, a silicone resin, a fluororesin, and a copolymer containing a monomer of these resins, and it is preferable to use the urethane resin.

In the ink according to this embodiment, it is preferable that a content of the binder d be 3 mass % or more in order to obtain high image adhesion to the recording medium. Furthermore, in the ink according to this embodiment, it is preferable that the content of the binder d be 15 mass % or less in order to ensure high ejectionability from the ejection head.

### (Silicone-Based Surfactant e)

The silicone-based surfactant e is a surfactant having siloxane bonds within its molecules. In the ink according to this embodiment, blending the silicone-based surfactant e can reduce the static surface tension as described above and improve wettability on the surface of the impermeable medium. A commercially available silicone-based surfactant includes, for example, Silface (registered trademark) SAG502 and Silface (registered trademark) SAG503A manufactured by Nissin Chemical Industries, Ltd.

### (Water)

In the ink according to this embodiment, water such as ion-exchanged water, purified water, or distilled water can be used. From the perspective of dryness and ejection reliability, it is preferable that the water content in the ink according to this embodiment be 40 mass % or more and 80 mass % or less.

### (Other Components)

The ink according to this embodiment may include components other than those described above as necessary. For example, the ink according to this embodiment may include a dispersant that enhances dispersibility of the pigment a in a solvent. As the dispersant, a pigment dispersing resin may be used. The pigment dispersing resin is water-soluble resin particles that form pigment dispersion together with the pigment a by adhering to the surface of the pigment a and suppressing its agglomeration. Examples of the pigment dispersing resin include a copolymer of at least one monomer selected from (meth)acrylic acid alkyl ester, styrene, and vinyl naphthalene and at least one monomer selected from (meth)acrylic acid and maleic acid.

As the pigment dispersing resin, a resin having a repeating unit derived from (meth)acrylic acid ((meth)acrylic acid unit), a repeating unit derived from (meth)acrylic acid alkyl ester ((meth)acrylic acid alkyl ester unit), and a styrene unit is preferred. In this case, a percentage of the (meth)acrylic acid unit among all repeating units in the pigment dispersing resin is preferably 4.5 mass % or more and 8.0 mass % or less. A percentage of the (meth)acrylic acid alkyl ester unit among all repeating units in the pigment dispersing resin is preferably 35 mass % or more and 70 mass % or less. A percentage of the styrene unit among all repeating units in the pigment dispersing resin is preferably 27.0 mass % or more and 60.0 mass % or less. As the pigment dispersing resin, a resin having a repeating unit derived from methacrylic acid, a repeating unit derived from methyl methacrylate, a repeating unit derived from butyl acrylate, and a styrene unit is more preferred.

In the ink according to this embodiment, a content of the pigment dispersing resin is preferably 0.5 mass % or more and 8.0 mass % or less, and more preferably 1.5 mass % or more and 4.0 mass % or less. Setting the content of the pigment dispersing resin to 0.5 mass % or more more effectively suppresses the agglomeration of the pigment a. Setting the pigment dispersing resin content to 8.0 mass % or less suppresses nozzle clogging in the ejection head.

Furthermore, the ink according to this embodiment may also include various additives such as a solubility stabilizer, an antioxidant, a viscosity modifier, a pH adjuster, and a neutralizing agent, as necessary, in addition to the pigment dispersing resin.

### EXAMPLES AND COMPARATIVE EXAMPLES

Inks were prepared and evaluated as Examples and Comparative Examples of the present disclosure. The following Examples merely show one example of the present disclosure and do not limit the scope of the disclosure to the configurations of Examples described below.

### (Preparation of Ink)

First, pigment dispersions were prepared by dispersing the pigment a in water. As the pigment dispersions, a cyan pigment dispersion a1, a black pigment dispersion a2, a yellow pigment dispersion a3, and a magenta pigment dispersion a4 were prepared. For the cyan pigment dispersion a1, C.I. Pigment Blue 15:3 (manufactured by BASF SE under the product name of HELIOGEN BLUE 7088) was used as the pigment a. For the black pigment dispersion a2, the pigment a was carbon black (manufactured by Orion Engineered Carbon S.A under the product name of Printex 85). For the yellow pigment dispersion a3, C.I. Pigment Yellow 74 (manufactured by Sanyo Pigment Co., Ltd., under the product name of FAST Yellow 7413) was used as the pigment a. For the magenta pigment dispersion a4, Pigment Red (manufactured by Dainichi Seika Kogyo Co., Ltd., under the product name of Red No. 63) was used as the pigment a.

For preparing the pigment dispersions a1 to a4, first, 15 parts of the pigment a, 10 parts of an acrylic resin (manufactured by BYK-Chemie GmbH under the product name of DISPERBYK-190 having a non-volatile content of 40%) as the pigment dispersing resin, and 75 parts of water were mixed and pre-dispersed using a disperser. Next, main dispersion was performed using a bead mill with a volume of 0.6 L filled with 1800 g of zirconia beads (diameter 0.1 mm) as a dispersion medium, yielding the pigment dispersions a1 to a4 (pigment solids: 15%).

Next, the inks used in Examples and Comparative Examples were prepared. For the inks used in Examples and Comparative Examples, any one of the pigment dispersions a1 to a4 was used as the pigment dispersion, triethylene glycol monobutyl ether was used as the glycol ether b, Superflex 870 (manufactured by DKS Co., Ltd.) was used as the binder d, and deionized water was used as the water.

Furthermore, for the inks used in Examples and Comparative Examples, one of the following water-soluble organic solvents c1 to c8 was used as the water-soluble organic solvent c.
c1: 1,2-propanediol
c2: 1,3-propanediol
c3: 3-methyl-1,3-butanediol
c4: 1,2-pentanediol
c5: 2-methyl-1,3-propanediol
c6: dipropylene glycol
c7: 1,5-pentanediol
c8: 3-methyl-1,5-pentanediol

Furthermore, in the inks used in Examples and Comparative Examples, one of the following silicone-based surfactants e1 and e2 was used as the silicone-based surfactant e.
e1: Silface SAG 502
e2: Silface SAG 503A

Table 1 shows types and contents (mass %) of components of cyan inks C1 to C14, black ink BK1, yellow ink Y1, and magenta ink M1 prepared as Examples and Comparative Examples. In preparing each ink, the pigment dispersion, the glycol ether b, the water-soluble organic solvent c, the binder d, the silicone-based surfactant e, and water were weighed into a beaker. A beaker content was stirred using a stirrer (manufactured by Shinto Scientific Co., Ltd. under the product name of “Three One Motor BL-600”) at a rotation speed of 400 rpm and was homogeneously mixed. The ink was filtered using a filter (pore size 5 μm) to remove impurities and coarse particles contained in the mixture. This yielded inks C1 to C14, BK1, Y1, and M1.

TABLE 1

| | | Ink | | | | | | | | | | | | | | | | |
|---|---|---|---|---|---|---|---|---|---|---|---|---|---|---|---|---|---|---|
| | | C1 | C2 | C3 | C4 | C5 | C6 | C7 | C8 | C9 | C10 | C11 | C12 | C13 | C14 | BK1 | Y1 | M1 |
| Pigment | a1 | 3 | 3 | 3 | 3 | 3 | 3 | 3 | 3 | 3 | 3 | 3 | 3 | 3 | 3 | | | |
| dispersion | a2 | | | | | | | | | | | | | | | 3 | | |
| | a3 | | | | | | | | | | | | | | | | 3 | |
| | a4 | | | | | | | | | | | | | | | | | 3 |
| Glycol ether b | | 15 | 15 | 15 | 15 | 15 | 15 | 15 | 15 | 15 | 15 | 15 | 15 | 15 | 15 | 15 | 15 | 15 |
| Water- | c1 | 27 | 28 | 30 | 35 | 36 | 30 | | | | | | | | 30 | 30 | 30 | 30 |
| soluble | c2 | | | | | | | 30 | | | | | | | | | | |
| organic | c3 | | | | | | | | 30 | | | | | | | | | |
| solvent | c4 | | | | | | | | | 30 | | | | | | | | |
| | c5 | | | | | | | | | | 30 | | | | | | | |
| | c6 | | | | | | | | | | | 30 | | | | | | |
| | c7 | | | | | | | | | | | | 30 | | | | | |
| | c8 | | | | | | | | | | | | | 30 | | | | |
| Binder d | | 4 | 4 | 4 | 4 | 4 | 4 | 4 | 4 | 4 | 4 | 4 | 4 | 4 | 4 | 4 | 4 | 4 |
| Surfactant | e1 | 0.1 | 0.1 | 0.1 | 0.1 | 0.1 | 0.01 | 0.1 | 0.1 | 0.1 | 0.1 | 0.1 | 0.1 | 0.1 | | 0.1 | 0.1 | 0.1 |
| | e2 | | | | | | | | | | | | | | 0.3 | | | |

| | | | | | | | | | | | | | | | | | |
|---|---|---|---|---|---|---|---|---|---|---|---|---|---|---|---|---|---|
| Ion-exchanged | 50.9 | 49.9 | 47.9 | 42.9 | 41.9 | 48.0 | 47.9 | 47.9 | 47.9 | 47.9 | 47.9 | 47.9 | 47.9 | 47.7 | 47.9 | 47.9 | 47.9 |
| water | | | | | | | | | | | | | | | | | |

For the inks C1 to C14, BK1, Y1, and M1, measurements were performed for the static surface tension at 25° C., the shear viscosity at the shear rate of 105 s−1 at 32° C., and the drying rate at 60 seconds after the ejection. Table 2 shows the static surface tension at 25° C., the shear viscosity at the shear rate of 105 s−1 at 32° C., and the drying rate at 60 seconds after the ejection for the inks C1 to C14, BK1, Y1, and M1.

TABLE 2

| | Ink | | | | | | | | | | | | | | | | |
|---|---|---|---|---|---|---|---|---|---|---|---|---|---|---|---|---|---|
| | C1 | C2 | C3 | C4 | C5 | C6 | C7 | C8 | C9 | C10 | C11 | C12 | C13 | C14 | BK1 | Y1 | M1 |
| Surface | 24.8 | 24.8 | 24.8 | 24.8 | 24.8 | 35.3 | 24.8 | 24.8 | 24.8 | 24.8 | 24.8 | 24.8 | 24.8 | 23.9 | 24.6 | 24.7 | 24.8 |
| tension | | | | | | | | | | | | | | | | | |
| (mN/m) | | | | | | | | | | | | | | | | | |
| Shear | 5.4 | 5.5 | 6.1 | 7.0 | 7.1 | 6.0 | 6.0 | 6.2 | 6.1 | 6.1 | 6.3 | 6.1 | 6.0 | 6.1 | 6.0 | 6.1 | 6.1 |
| viscosity | | | | | | | | | | | | | | | | | |
| (mPa · s) | | | | | | | | | | | | | | | | | |
| Drying rate | 27.7 | 29.6 | 30.5 | 32.8 | 35.8 | 30.7 | 31.5 | 32.1 | 30.7 | 30.6 | 30.4 | 32.1 | 31.5 | 30.4 | 31.0 | 32.0 | 31.5 |
| (%) | | | | | | | | | | | | | | | | | |

The inks C2 to C5, C7 to C14, BK1, Y1, and M1 have ink compositions according to the above embodiments. On the other hand, the ink C1 differs from the compositions of the above embodiments in that the drying rate at 60 seconds after the ejection is less than 28%. The ink C5 differs from the compositions of the above embodiments in that the drying rate at 60 seconds after the ejection is greater than 35%. The ink C6 differs from the compositions of the above embodiments in that the static surface tension at 25° C. exceeds 25 mN/m.

### (Evaluation for Misdirected Ejection of Ink)

For evaluating the misdirected ejection of the ink, an inkjet recording apparatus (equipped with a Megajet circulation pump and a line head, Kyocera Document Solutions test machine) having the configuration of the above embodiments was used as an evaluation machine. Droplet placement precision of the ejection head was measured after performing purge and wipe operations following 5000 consecutive prints. An image of dot lines, as shown in FIG. 2, was formed on inkjet matte paper (Epson Super Fine paper). A line spacing (line pitch) was calculated at 16-pixel intervals, and a variation in the line pitch (3σ) was calculated. The misdirected ejection for each ink was evaluated based on the following criteria A to C. For the misdirected ejection of the ink, evaluation A is passed, while evaluations B and C are failed.
A: 3σ of line pitch is less than 20 μm
B: 3σ of line pitch is 20 μm or greater
C: Unable to evaluate due to no ejection

### Examples 1 to 28

In Examples 1 to 14, the ink before the ejection was circulated at the flow rate of 40 ml/min. In Examples 15 to 28, the ink before the ejection was circulated at the flow rate of 70 ml/min. Table 3 shows each ink type, each ink circulation time before the ejection, and each 3σ of the line pitch and each evaluation for the misdirected ejection for Examples 1 to 14. Table 4 shows each ink type, each ink circulation time before the ejection, and each 30 of the line pitch and each evaluation for the misdirected ejection for Examples 15 to 28. Examples 1 to 28 all have the configurations described in the above embodiments. In each of Examples 1 to 28, the 3σ of the line pitch was less than 20 μm, and the evaluation for the misdirected ejection of the ink was passed.

TABLE 3

| | | Example | | | | | | | | | | | | | |
|---|---|---|---|---|---|---|---|---|---|---|---|---|---|---|---|
| | | 1 | 2 | 3 | 4 | 5 | 6 | 7 | 8 | 9 | 10 | 11 | 12 | 13 | 14 |
| Ink | | C3 | C14 | C2 | C4 | C7 | C8 | C9 | C10 | C11 | C12 | C13 | BK1 | Y1 | M1 |
| Circulation time (time) | | 1 | 1 | 1 | 1 | 1 | 1 | 1 | 1 | 1 | 1 | 1 | 1 | 1 | 1 |
| Misdirected | 3σ (μm) | 16.8 | 18.3 | 18.8 | 17.8 | 17.3 | 17.8 | 18.3 | 19.1 | 17.7 | 18.4 | 18.3 | 18.3 | 17.7 | 17.3 |
| ejection | Evaluation | A | A | A | A | A | A | A | A | A | A | A | A | A | A |

TABLE 4

| | | Example | | | | | | | | | | | | | |
|---|---|---|---|---|---|---|---|---|---|---|---|---|---|---|---|
| | | 15 | 16 | 17 | 18 | 19 | 20 | 21 | 22 | 23 | 24 | 25 | 26 | 27 | 28 |
| Ink | | C3 | C14 | C2 | C4 | C7 | C8 | C9 | C10 | C11 | C12 | C13 | BK1 | Y1 | M1 |
| Circulation time (time) | | 1 | 1 | 1 | 1 | 1 | 1 | 1 | 1 | 1 | 1 | 1 | 1 | 1 | 1 |
| Misdirected | 3σ (μm) | 17.2 | 18.9 | 19.6 | 18.7 | 17.7 | 18.2 | 18.2 | 17.4 | 19.3 | 18.8 | 19.5 | 19.1 | 18.6 | 18.9 |
| ejection | Evaluation | A | A | A | A | A | A | A | A | A | A | A | A | A | A |

### Comparative Examples 1 to 8

In Comparative Examples 1 to 4, the ink before the ejection was circulated at the flow rate of 40 ml/min. In Comparative Examples 5 to 8, the ink before the ejection was circulated at the flow rate of 70 ml/min. Table 5 shows each ink type, each ink circulation time before the ejection, and each 30 of the line pitch and each evaluation for the misdirected ejection for Comparative Examples 1 to 4. Table 6 shows each ink type, each ink circulation time before the ejection, and each 36 of the line pitch and each evaluation for the misdirected ejection for Comparative Examples 5 to 8. Comparative Examples 1 and 5 differ from the above embodiments in that they use the ink C6, which has the static surface tension exceeding 25 mN/m at 25° C. Comparative Examples 2 and 6 differ from the above embodiments in that the ink is not circulated before the ejection. Comparative Examples 3 and 7 differ from the above embodiments in that they use the ink C1, which has the drying rate of less than 28% at 60 seconds after the ejection. Comparative Examples 4 and 8 differ from the above embodiments in that they use the ink C5, which has the drying rate of more than 35% at 60 seconds after the ejection. Comparative Examples 1 to 8 all failed the evaluation for the misdirected ejection of the ink.

TABLE 5

Comparative Example

| | | | 1 | 2 | 3 | 4 |
|---|---|---|---|---|---|---|
| Ink | | | C6 | C3 | C1 | C5 |
| Circulation time (time) | | | 1 | 0 | 1 | 1 |
| | Misdirected | 3 σ | 20.2 | 22.3 | 24.3 | — |
| | ejection | (μm) | | | | |
| | | Evaluation | B | B | B | C |

TABLE 6

Comparative Example

| | | | 5 | 6 | 7 | 8 |
|---|---|---|---|---|---|---|
| Ink | | | C6 | C3 | C1 | C5 |
| Circulation time (time) | | | 1 | 0 | 1 | 1 |
| | Misdirected | 3 σ | 20.6 | 21.6 | — | 33.5 |
| | ejection | (μm) | | | | |
| | | Evaluation | B | B | C | B |

It should be understood by those skilled in the art that various modifications, combinations, sub-combinations and alterations may occur depending on design requirements and other factors insofar as they are within the scope of the appended claims or the equivalents thereof.

What is claimed is:

1. An inkjet recording apparatus, comprising:
an ejection head for ejecting ink;
an ink tank for reserving the ink;
a circulation section having a circulation path connecting the ejection head and the ink tank that circulates the ink between the ejection head and the ink tank at a flow rate of 40 ml/min or more and 70 ml/min or less via the circulation path;
a degassing section provided in the circulation path that degasses the ink flowing through the circulation path; and
a control section that controls the ejection head to eject the ink after the circulation section circulates the ink,
wherein the ink contains a pigment, a glycol ether, 28 mass % or more and 35 mass % or less of a water-soluble organic solvent, a water-insoluble resin, 0.05 mass % or more of a silicone-based surfactant, and water,
wherein the water-soluble organic solvent is at least one of 1,2-propanediol, 3-methyl-1,3-butanediol, 1,2-pentanediol, 2-methyl-1,3-propanediol, 1,3-propanediol, dipropylene glycol, 1,5-pentanediol, and 3-methyl-1,5-pentanediol,
wherein static surface tension of the ink at 25° C. is 25 mN/m or less,
wherein shear viscosity of the ink at 32° C. at a shear rate of 105 s−1 is 5.5 mPa·s or more and 7 mPa·s or less, and
wherein a drying rate of the ink is 28% or more and 35% or less at 60 seconds after the ejection from the ejection head.

2. The inkjet recording apparatus according to claim 1, wherein the control section controls the ejection head to eject the ink after the circulation section circulates the ink for 0.5 hours or more.

3. The inkjet recording apparatus according to claim 1, wherein a dissolved oxygen content in the ink immediately before the ejection by the ejection head is 8.5 mg/L or less.

4. An inkjet recording method using an inkjet recording apparatus, wherein the inkjet recording apparatus comprises
an ejection head for ejecting ink;
an ink tank for reserving the ink;
a circulation section having a circulation path connecting the ejection head and the ink tank that circulates the ink between the ejection head and the ink tank at a flow rate of 40 ml/min or more and 70 ml/min or less via the circulation path; and
a degassing section provided in the circulation path that degasses the ink flowing through the circulation path,
wherein the ink contains a pigment, a glycol ether, 28 mass % or more and 35 mass % or less of a water-soluble organic solvent, a water-insoluble resin, 0.05 mass % or more of a silicone-based surfactant, and water,
wherein the water-soluble organic solvent is at least one of 1,2-propanediol, 3-methyl-1,3-butanediol, 1,2-pentanediol, 2-methyl-1,3-propanediol, 1,3-propanediol, dipropylene glycol, 1,5-pentanediol, and 3-methyl-1,5-pentanediol,
wherein static surface tension of the ink at 25° C. is 25 mN/m or less,
wherein shear viscosity of the ink at 32° C. at a shear rate of 105 s−1 is 5.5 mPa·s or more and 7 mPa·s or less,
wherein a drying rate of the ink is 28% or more and 35% or less at 60 seconds after the ejection from the ejection head, and
wherein the ink is ejected by the ejection head after the circulation section circulates the ink through the circulation path.

5. The inkjet recording method according to claim 4, wherein the ink is ejected by the ejection head after the circulation section circulates the ink for 0.5 hours or more.
